(19) United States
(12) Patent Application Publication
(10) Pub. No.: US 2007/0119899 A1
(43) Pub. Date: May 31, 2007

(54) Pneutmatic fixing machine

(75) Inventor: Marco Ronconi, Bologna (IT)

Correspondence Address: WILLIAM J. SAPONE;COLEMAN SUDOL SAPONE P.C., 714 COLORADO AVENUE, BRIDGE PORT, CT, 06605, US

(73) Assignee: FASCO S.P.A., CADRIANO DI GRANAROLO EMILIA (IT)

(21) Appl. No.: 10/581,150

(22) PCT Filed: Dec. 10, 2004
(86) PCT No.: PCT/IB04/04082

§ 371 Date: May 31, 2006

(30) Foreign Application Priority Data
Dec. 10, 2003 (IT) BO2003A000740

(51) Int. Cl. B25C 1/04

(52) U.S. Cl. 227/130

(57) ABSTRACT

A pneumatic fixing machine comprises a piston mean (30) sliding into a cylinder (33); first valve means (5) mobile between two extreme opening (E) and closing (D) positions, in correspondence of which they connect in flow communication a inlet portion (33a) of said cylinder (33) respectively with a feeding of pressurized fluid and with an external outlet; second valve means (2) which can be operated by means of a trigger mean (7) and mobile at least between an occlusion position (M) and a passage position (L) to connect in flow connection, through at least a first duct (9), a base portion (5a) of the first valve means (5) respectively with the feeding of fluid in pressure and with an external outlet. The machine (1) comprises:—third valve means (3) mobile between a position of obstruction (N) and a crossing position (Q), respectively to cut off or to open a flow connection between the duct (9) and the first valve means (5);—fourth valve means (4) which can be operated by means of the trigger mean (7) and mobile between a block position (S) and a transit position (T), in which respectively they obstruct or make free a flow connection between the cylinder (33) and the third valve means (3).

### TECHNICAL FIELD

The present invention relates to the technical field of the portable pneumatic fixing machines, such as riveting machines, staplers, and particularly it refers to a pneumatic fixing machine provided for a manual use and able to operate in single hit or in automatic modality with repeated hits.

### BACKGROUND ART

There are known machines as staplers e/o riveting compressed air machines provided with valves and control and regulation means allowing the single hit or automatic repetition operation or the release of a single fixing mean, for instance a metallic staple, a pin, a nail, etc., or the release of a plurality of such fixing means in sequence, with different timing.

The actuating of the two different modalities is generally obtained by partially or completely, up the stop, pressing the trigger of the utensil or pressing two separate triggers or pushers.

Such trigger or pusher, in fact, subsequently crushes two separate command pivots placed side by side, that act on respective pneumatic valves.

Typically, partially pressing the trigger, is obtained the single hit operating, and the automating working pressing it to the stop of the stroke.

A disadvantage of such type of operation consists in the excessive sensibility and attention required to the operator for pressing the trigger, in order to avoid to unintentionally and unawares operate the automatic operation rather than the single hit.

They are also known staplers machines in which the trigger commands only the automatic operation of the machine that can be inhibited to have the single hit through the operation of a pusher or button, that it operates an opportune pneumatic circuit.

In this case, the disadvantage resides in the discomfort of employment of the machine, because the operator is forced, to get the single hit, to press the trigger with the index and contemporarily the button with the thumb of the same hand, by realizing a non optimal handling and, therefore, inadequate firm and sure of the utensil.

In the known stapler machines, the fixing means are hammered in the piece to be worked through a beating blade, that is powered by an compressed air piston.

The piston is brought then in the initial position through the opening e/o closing of opportune valves or other pneumatic organs, typically distributors or exchangers automatically or manually commuted.

A drawback of such known machines consists in their structural and constructive complexity, that comprises numerous parts and components, resulting therefore expensive to build and to assemble.

### DISCLOSURE OF THE INVENTION

An object of the present invention is to propose a pneumatic fixing machine to operate in both single or automatic repeated high frequency hit modality, that is compact and having a relatively simple structure, with a small number of components, therefore economic to realize and to assemble.

Other object is to propose a machine having sure and reliable operation, simple to be used also by a unskilled operator, reducing the risk of an unintentional actuating of the automatic modality at minimum.

Further object is to propose a fixing machine that allows the operator a firm and sure, correct and comfortable handling from the ergonomic point of view.

The above mentioned objects are achieved in accord with the content of the claims.

### BRIEF DESCRIPTION OF THE DRAWINGS

The characteristics of the present invention are underlined in the following with particular reference to the enclosed drawings, in which:

FIG. 1 illustrate a sectional view of the pneumatic stapler machine object of the present invention, in association with a magazine for fixing means, in a non operation condition of the same machine;

FIG. 2 illustrate a partial enlarged view of FIG. 1;

FIG. 3 illustrate a section partial view of FIG. 2 machine in a first activation condition;

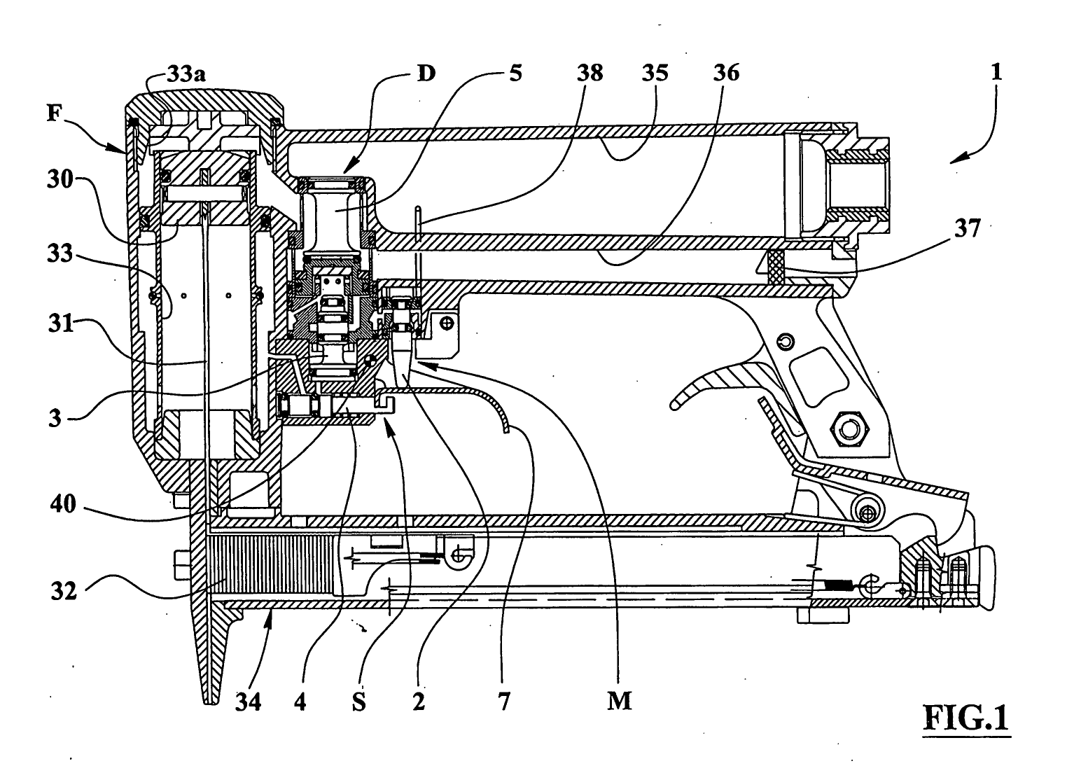

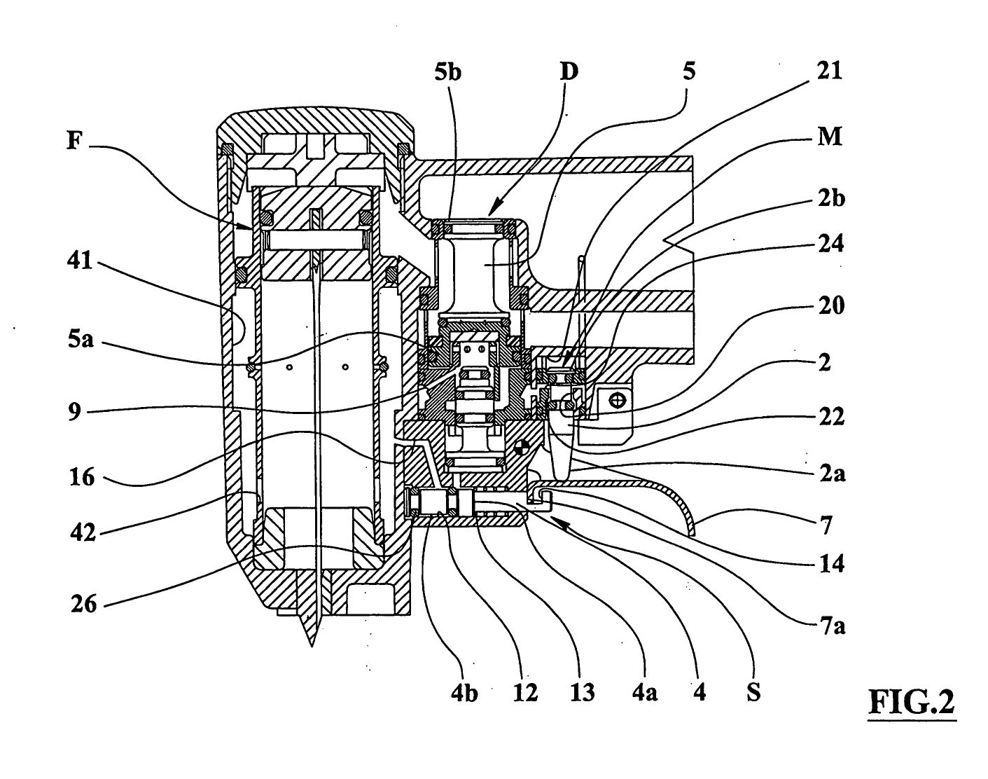

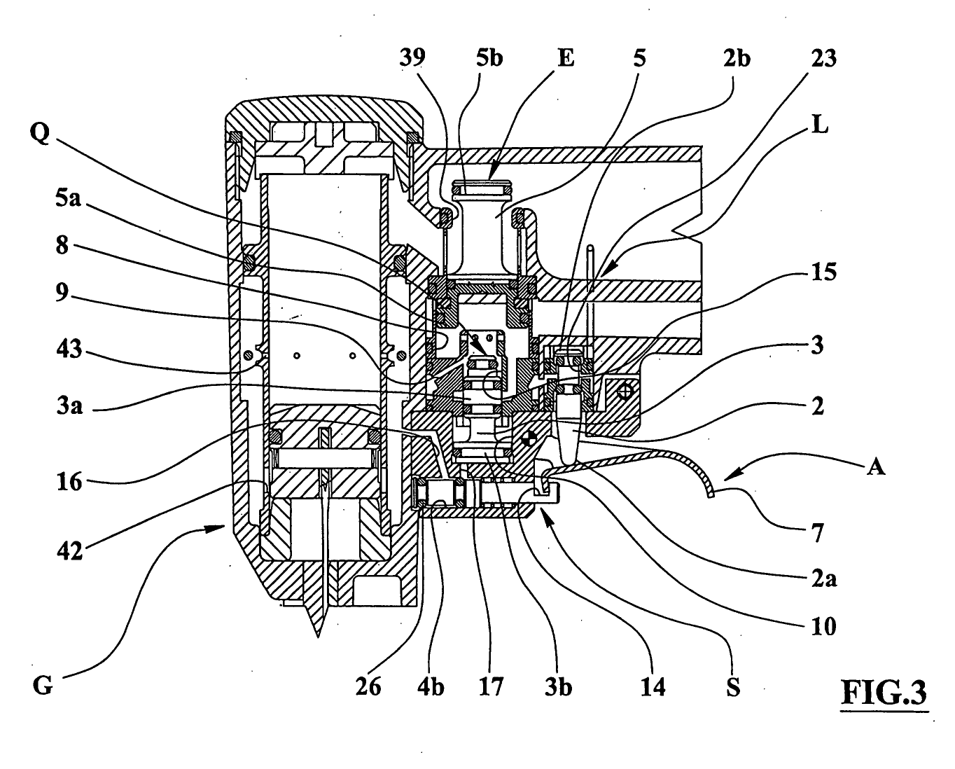

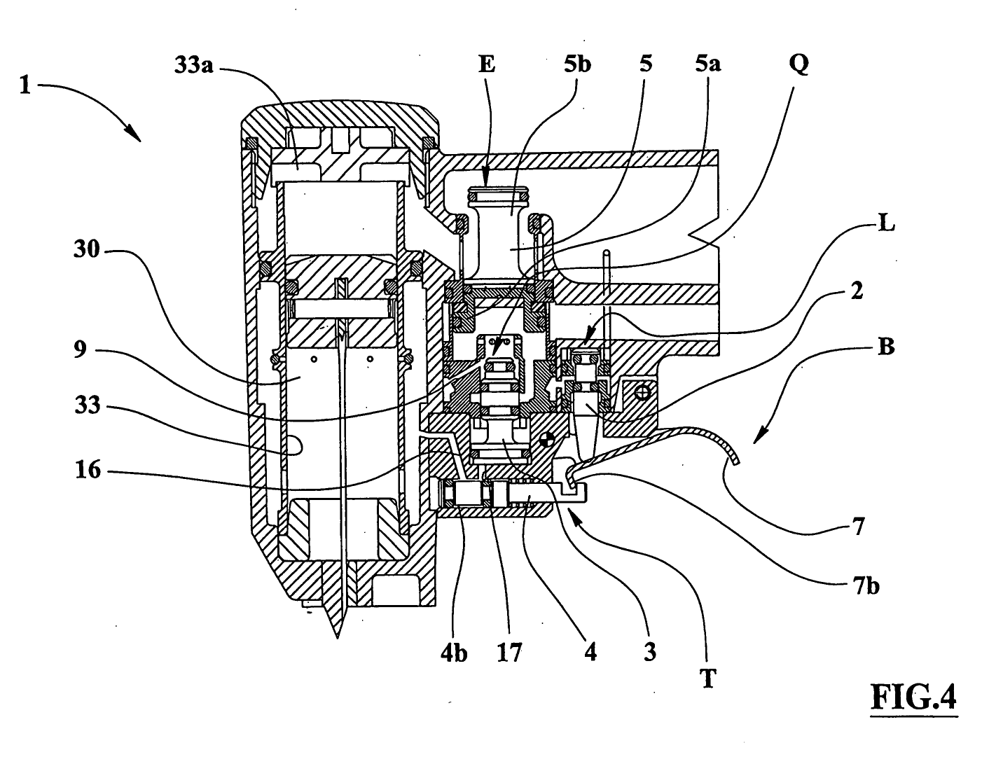

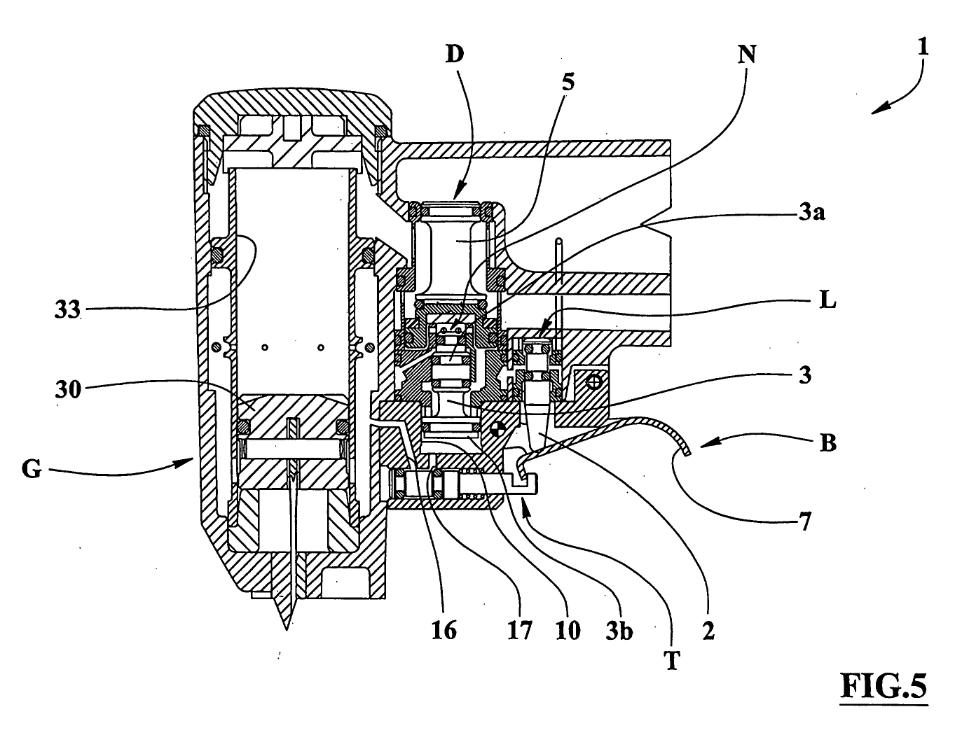

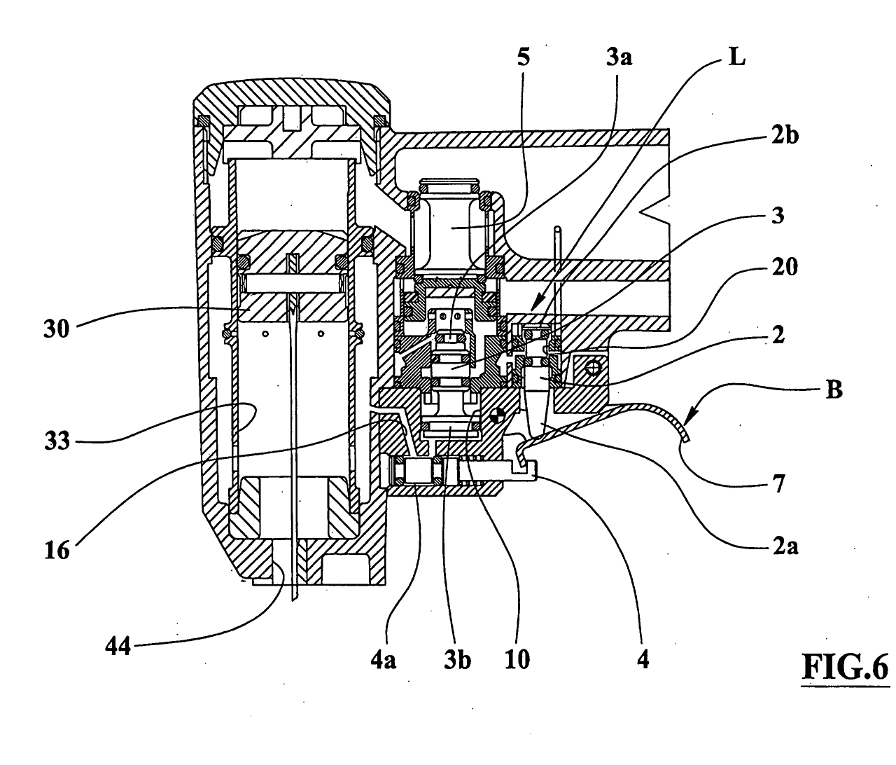

FIGS. from 4 to 6 illustrate partial sectional views of the machine of FIG. 2 in respective and subsequent operation phases, in correspondence of a second activation condition of the machine the same.

### BEST MODE OF CARRYING OUT THE INVENTION

With reference to the figures from 1 to 6, with 1 is designed the pneumatic fixing machine, object of the present invention, of the type comprising a piston mean 30, sliding inside a cylinder 33 and supporting a beating blade 31, fit to act on a fixing 20 mean 32, for instance a metallic staple or a pin, contained in a magazine 34 of known type and associated to the machine 1. The piston is actuated and controlled in its motion through first valve means 5, second 2, third 3 and fourth 4 located inside the machine 1.

The first valve means 5 are mobile between two extreme opening E and closing D 25 positions, in correspondence of which they connect in flow communication an inlet portion 33a of said cylinder 33 respectively with a feeding of pressurized fluid and with an external outlet.

More precisely, the inlet portion 33a can selectively be connected in communication 30 with a feeding room 35 containing pressurized air and connected to an external source of compressed air, such as a compressor or a fixed plant pneumatic network, or with a outlet duct 36, flowing in the external environment through a filter silencer 37.

The second valve means 2 are movable by means of a trigger mean 7 and they are mobile between two extreme positions, of occlusion M and of passage L, in which they connects a base portion 5a of the first valve means 5 in flow communication, through a first duct 9, respectively with the feeding of pressure fluid and with an external outlet.

The first valve means 2 substantially consist of a lengthened and shaped element, typically a varying section cylindrical stem, that is sliding housed in a third seat 20, having complementary cylindrical shape, provided with a plurality of openings: a first opening 23, positioned to an upper end of such seat 20, flows in a third room 21, that is in flow connection, through a channel 38, with the feeding room 35; a plurality of second openings 24 on the side walls of the seat 20 and connected to the first duct 9; and a third opening 22, positioned to the opposite extreme of the third seat 20 with respect to the first opening 23, that flows outside, for the air outlet.

The cylindrical stem of the second valve means 2 has an external portion 2a, protruding externally in the third seat 20 and fit to match the trigger mean 7 and a lock portion 2b, opposite to said external portion 2a and fit for closing the first opening 23 of the third seat 20 in the occlusion position M of said first valve means 2.

The third valve means 3 are mobile between an occlusion position N and a crossing position Q, in which they can respectively close or open the flow connection between the duct 9 and the first valve means 5.

The third valve means 3 essentially consist of a shaped stem, typically a cylindrical stem having a ranging section, comprising two end portions, first 3a and second 3b, respectively sliding housed in a second seat 15 and in a first room 10.

The first end portion 3a is shaped to close the exit of the first duct 9 inside the second seat 15 in the occlusion position N of the third valve means 3, while the second end portion 3b is subject to the force of the pressurized fluid contained in the first room 10.

The second end portion 15 upwardly flows into a second room 8 in which the base portion 5a of the first valve means 5 is sliding housed.

The first valve means 5 include, besides, a closing portion 5b fit to cut off the pressurized fluid flow in the closing condition D. In particular, said closing portion 5b is able to seal a fourth outlet opening 39 of the feeding room 35. The closing portion 5b have an equivalent transversal section smaller than the base portion 5a. Similarly, the first end portion 3a of the third valve means has an equivalent transversal section smaller than the second end portion 3b.

The forth valve means 4 are also operated by the trigger mean 7 and are mobile between a block position S and a transit position T, in which they respectively allows to close or to open the flow connection between the cylinder 33 and the third valve means 3.

The fourth valve means 4 are constituted by a lengthened element and shaped, preferably a cylindrical stem, sliding housed in a first seat 12, having cylindrical complementary shape and in flow connection with the cylinder 30, though at least a second duct 16, and with the first room 10, through a third duct 17.

In the illustrated embodiment, the geometric axis of the valve means second 2 and fourth 4 are mutually perpendicular and the geometric axis of the first 5 and third 3 valve means are nearly coincident and nearly parallel to the axis of the second valve means 2.

The fourth valve means 4 include an hollow 14, carried out in a portion of the cylindrical stem, protruding externally outward the first seat 12, and in which a shaped free end 7a of the trigger mean 7 is engaged therein. The shape and the dimensions of the hollow 14 and of the free end 7a are fit for the mutual engagement and therefore the translation of the stem, only for a rotation, bigger then a certain angular value, of the trigger 7 that it is pivoting around a pivot 40.

They are provided, besides, elastic means 13, properly sized to exert an elastic strength on the fourth valve means 4 and to maintain them, in absence of external strengths practiced by the trigger mean 7, in the block position S. The elastic means 13 preferably consist of a compression operating helical spring, and housed in the first seat 12 in order to match a bottom wall of this last and a prominence 4a of the fourth valve means 4.

The elastic means 13 can be sized for developing an antagonist strength of desired intensity, depending on the specific user requirements, for instance to make the second part of the rotation of the trigger mean 7 more tenacious and therefore mostly perceptible.

The fourth valve means 4 include, besides, an hollow 4b, essentially constituted by a portion of the cylindrical stem, having a reduced diameter with respect to the first seat 12 and delimited by a couple of ring fingers 26, typically “Or-ring” gaskets, said hollow 4b being provided to connect in flow communication the second 16 and third 17 ducts in the transit position T of said fourth valve means 4.

The operation of the pneumatic fixing machine 1, object of the present invention, provides that in a first activation condition A of the same, the trigger mean 7 is partially pressed, in order to move the second valve means 2 from the occlusion position M, in which they are maintained by the pressure of the fluid present in the third room 21, to the passage position L, in which they allows the compressed air to reach to the second room 8 an act on the base portion 5a, having bigger equivalent transversal section in respect to that of the closing portion 5b, in order to push the first valve means 5 in the opening position E.

In this way, through the fourth opening 39 of the feeding room 35, the pressurized air reaches the inlet portion 33a of the cylinder 33 strongly pushing the piston mean 30 from an inside position F to an external position G, in which the beating blade 31 hammers the fixing mean 32 in the part to be fixed.

The release of the trigger mean 7 determines the return of the second valve means 2 in the occlusion position M, with the consequent closing of the first opening 23 and the unloading, through the third opening 22, of-the third seat 20 and, through the first duct 9, of the second room 8. This determines the return of the first valve means 5 in the closing position D, with the interruption of the feeding of the compressed air to the piston mean 30. The return of this last in the upper initial position F is ensured by the expansion of the compressed air, contained in a saving ring room 41 of known type, that it expands in the cylinder 30 through first side openings 42. The entry of the compressed air in the saving ring room 41 occurs through second side openings 43, during the stroke of the piston mean 30.

In a second activation condition B of the machine 1, the trigger mean 7 is further completely pressed up to transfer the fourth valve means 4 from the halt position S to the transit position T, exceeding the antagonist elastic strength of the elastic means 13.

In this position, when the piston mean 30 comes in the external position G, in accord with the above described operational sequence, the compressed air, that fills the saving ring room 41, can reach the first room 10, crossing in sequence the second duct 16, the hollow 4b of the fourth valve means 4 and the third duct 17.

In the room 10 the compressed air acts on the second end portion 3b having equivalent transversal section bigger than that of the first portion 3a, in order to push the third valve means 3 from the crossing position Q to the occlusion position N, in order to cut off the pressurized air flow coming from the duct 9 and direct to the second room 8.

The lack of compressed air in said room 8 determines the return of the first valve means 5 in the closing position D or the interruption of the compressed air feeding to the piston mean 30.

Also in this case the return of this last in the inside superior initial position F is realized by the expansion of the compressed air, contained in the saving ring room 41 of known type, that it expands in the cylinder 30 and subsequently it flows through opportune outlet 44 to the outside. At this step, the cylinder 30, the saving ring room 41 and consequently the second duct 16, the hollow 4b, the third duct 17 and the first room 10 are at atmospheric pressure.

Since the trigger mean 7 is still pressed and maintain the second valve means 2 in the passage position L, the compressed air is free to reach the second seat 15, causing the moving of the third valve means 3 in the crossing position Q and subsequently, reaching to the second room 8, the moving of the first valve 5 in the opening position E for a new stroke of the piston mean 30.

The cycle automatically repeats as above explained up to the release of the trigger mean 7 allowing the machine 1 to perform repeated hits, with a frequency or adjustable frequency controllable by regulation means of compressed air flow, of known type and not illustrated.

An advantage of the present invention is to provide a pneumatic fixing machine to indifferently operate in single hit or automatic repeated hits modality, endowed with a compact structure and relatively simple, with a small number of components, therefore economic to be made and assembled.

Other advantage is to provide a sure and reliable operation machine, that is also simple to be used by an unskilled operator, and reducing to the minimum the risk of an unintentional actuating of the automatic modality.

Further advantage consists in providing a fixing machine that allows the operator a firm and sure handling, right and comfortable from the ergonomic point of view.

1) Pneumatic fixing machine comprising a piston mean (30) sliding inside a cylinder (33); first valve means (5) mobile between two extreme opening (E) and closing (D) positions, in correspondence of which they connect in flow communication a inlet portion (33a) of said cylinder (33) respectively with a feeding of pressurized fluid and with an external outlet; second valve means (2) which can be operated by means of a trigger mean (7) and mobile at least between an occlusion position (M) and a passage position (L) to connect in flow connection, through at least a first duct (9), a base portion (5a) of the first valve means (5) respectively with the feeding of fluid in pressure and with an external outlet; said machine (1) being characterized in that at least comprises:
third valve means (3) mobile between a position of obstruction (N) and a crossing position (Q), respectively to cut off or to open a flow connection between the duct (9) and the first valve means (5);
fourth valve means (4) which can be operated by means of the trigger mean (7) and mobile between a block position (S) and a transit position (T), in which respectively they obstruct or make free a flow connection between the cylinder (33) and the third valve means (3);
in a first activation condition (A) of the machine (1), the trigger mean (7) is partially pressed, positioning the second valve means (2) in the passage position (L), in order to allow the pressurized fluid to push the first valve means (5) in the opening position (E), for the actuating of the piston mean (30); in a second activation condition (B) of the machine (1), the trigger mean (7) is further and completely pressed and it moves the fourth valve means (4) in the transit position (T), in order to allow the fluid in pressure coming from the cylinder (33) to move the third valve means (3) in the occlusion position (N), causing the return of the first valve means (5) in the closing position (D) and the consequent return of the piston mean (30) in the initial position (F).

2) Machine according to claim 1 characterized in that the fourth valve means (4) comprise a lengthened and shaped element, sliding housed inside a first seat (12), being complementary shaped and in flow connection with the cylinder (30) through at least a second duct (16).

3) Machine according to claim 2 characterized in that the fourth valve means (4) comprise at least an hollow (14) in which a shaped free end (7a) of the trigger mean (7) is engaged.

4) Machine according to claim 1 characterized in that it comprises elastic means (13) fit for exerting an elastic strength on the fourth valve means (4) and to maintain them, in absence of strengths exerted by the trigger mean (7), in the block position (S).

5) Machine according to claim 2 characterized in that the elastic means (13) consist in at least a compression operating helical spring, housed in the first seat (12) and matching a prominence (4a) of the fourth valve means (4).

6) Machine according to claim 1 characterized in that the third valve means (3) comprise a shaped stem provided at least of end portions first (3a) and second (3b), respectively sliding housed in a second seat (15) and a first room (10); the first end portion (3a) being fit to occlude the exit of the first duct (9) inside the second seat (15) in the occlusion position (N) of the third valve means (3).

7) Machine according to claim 6 characterized in that the second end portion (3b) has an equivalent transversal section greater than that of the first portion (3a).

8) Machine according to claims 2 and 6 characterized in that it comprises at least a third duct (17) for the flow connection between the first seat (12) and the first room (10).

9) Machine according to claims 2 and 8 characterized in that the fourth valve means (4) comprise an hollow (4b) to connect in flow communication the ducts second (16) and third (17) in the transit position (T) of said fourth valve means (4).

10) Machine according to claim 6 characterized in that the base portion (5a) of the first valve means (5) is sliding contained in a second room (8) in flow communication with the second seat (15).

11) Machine according to claim 1 characterized in that the first valve means (5) comprise a closing portion (5b) fit to cut off the pressurized fluid flow in the closing condition (D); said closing portion (5b) having a smaller equivalent transversal section of that of the base portion (5a).

12) Machine according to claim 6 characterized in that the first valve means (2) comprise a lengthened and shaped element, sliding housed in a third seat (20), provided with a first opening (23), flowing in a third room (21) that it is in flow connection with the feeding of the fluid in pressure, of at least a second opening (24) intermediate and connected to the at least first duct (9) and of a third opening (22) for connecting with the external outlet.

13) Machine according to claim 12 characterized by the fact the first valve means (2) comprise at least an external portion (2a), fit to match the trigger mean (7), and a lock portion (2b), opposite to said external portion (2a) and fit for closing the first opening (23) of the third seat (20) in the occlusion position (M) of said first valve means (2).

14) Machine according to claim 1 characterized by the fact the geometric axis of the valve means second (2) and fourth (4) are mutually perpendicular.

15) Machine according to claim 1 characterized by the fact the geometric axis of the first valve means (5) and third (3) are nearly coincident and nearly parallel to the axis of the second valve means (2).
